(19) United States
(12) Patent Application Publication
(10) Pub. No.: US 2025/0310643 A1
(43) Pub. Date: Oct. 2, 2025

(54) CONTROL METHOD, CONTROL DEVICE, AND ELECTRONIC DEVICE

(71) Applicant: Lenovo (Beijing) Limited, Beijing (CN)

(72) Inventors: Wei LI, Beijing (CN); Xin ZHAO, Beijing (CN)

(21) Appl. No.: 19/091,320

(22) Filed: Mar. 26, 2025

(30) Foreign Application Priority Data
Mar. 28, 2024 (CN) 202410368029.9

(51) Int. Cl. H04N 23/68; H04N 23/80; H04N 23/90

(52) U.S. Cl. CPC H04N 23/681; H04N 23/80; H04N 23/90

(57) ABSTRACT

A control method includes: obtaining a first captured image through a first camera; obtaining sensing parameters through a motion sensor, where the sensing parameters are configured to characterize movement of an electronic device; and in response to the sensing parameters satisfying a switching condition, switching from the first camera to a second camera to obtain a second captured image. The first camera and the motion sensor belong to the same electronic device, and the first camera is different from the second camera.

### CROSS-REFERENCE TO RELATED APPLICATION

This application claims priority to Chinese Patent Application No. 202410368029.9, filed on Mar. 28, 2024, the entire content of which is incorporated herein by reference.

### TECHNICAL FIELD

The present disclosure generally relates to the field of electronic device application technologies and, more particularly, to a control method, a control device, and an electronic device thereof.

### BACKGROUND

In actual applications, to satisfy different image acquisition requirements, a photographer can select a most suitable camera for image acquisition from a main camera, a wide-angle camera, a telephoto camera, a macro camera, or a depth-of-field camera, according to the photographing environment, to satisfy the actual photographing requirements.

At present, the photographer usually selects the suitable camera for image acquisition based on experience or experiments. For inexperienced photographers, it is time-consuming and laborious, and the quality of the captured image cannot be guaranteed, which reduces the efficiency and reliability of image acquisition.

### SUMMARY

In accordance with various embodiments of the present disclosure, there is provided a control method, including: obtaining a first captured image through a first camera; obtaining sensing parameters through a motion sensor, where the sensing parameters are configured to characterize movement of an electronic device; and in response to the sensing parameters satisfying a switching condition, switching from the first camera to a second camera to obtain a second captured image. The first camera and the motion sensor belong to the same electronic device, and the first camera is different from the second camera.

In accordance with various embodiments of the present disclosure, there is also provided an electronic device, including: a first camera, configured to obtain a first captured image; a motion sensor, configured to obtain sensing parameters, where the sensing parameters are configured to characterize movement of an electronic device; and one or more processors respectively connected to the first camera and the motion sensor, configured to: receive the first captured image and the sensing parameters; and, in response to the sensing parameters satisfying a switching condition, switch from the first camera to a second camera to obtain a second captured image. The first camera is different from the second camera.

In accordance with various embodiments of the present disclosure, there is also provided a non-transitory computer readable storage medium containing computer instructions that, when being executed, cause at least one processor to perform obtaining a first captured image through a first camera; obtaining sensing parameters through a motion sensor, wherein the sensing parameters are configured to characterize movement of an electronic device; and in response to the sensing parameters satisfying a switching condition, switching from the first camera to a second camera to obtain a second captured image. The first camera and the motion sensor belong to the same electronic device, and the first camera is different from the second camera.

### BRIEF DESCRIPTION OF THE DRAWINGS

FIG. 1 illustrates a flow chart of a control method consistent with various embodiments of the present disclosure.

FIG. 2 illustrates a schematic diagram of an optional application environment architecture of a control method consistent with various embodiments of the present disclosure.

FIG. 3 illustrates a schematic diagram of another optional application environment architecture of a control method consistent with various embodiments of the present disclosure.

FIG. 4 illustrates a flow chart of another control method consistent with various embodiments of the present disclosure.

FIG. 5 illustrates a schematic diagram of an optional photographing scenario of a control method consistent with various embodiments of the present disclosure.

FIG. 6 illustrates a schematic structural diagram of a control device consistent with various embodiments of the present disclosure.

FIG. 7 illustrates a schematic structural diagram of an electronic device consistent with various embodiments of the present disclosure.

FIG. 8 illustrates a schematic structural diagram of another electronic device consistent with various embodiments of the present disclosure.

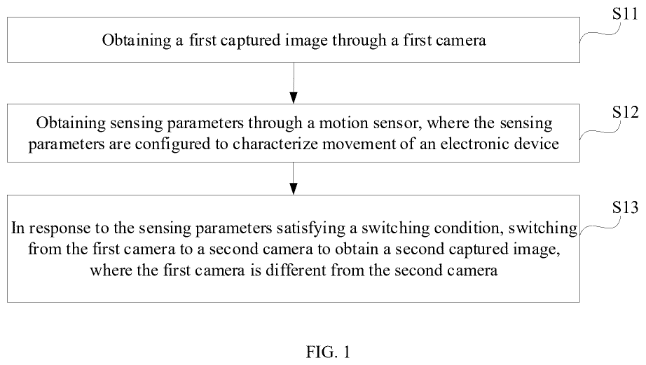

### DETAILED DESCRIPTION OF THE EMBODIMENTS

Specific embodiments of the present disclosure are hereinafter described with reference to the accompanying drawings. The described embodiments are merely examples of the present disclosure and should not be regarded as limitations of this application. All other embodiments obtained by those of ordinary skill in the art without creative efforts fall within the scope of protection of the present disclosure.

In the present disclosure, reference is made to “some embodiments” which describe a subset of all possible embodiments, but it is understood that “some embodiments” may be the same subset or a different subset of all possible embodiments, and can be combined with each other without conflict.

The terms “first/second/third” involved are only configured to distinguish similar objects and do not represent a specific ordering of objects. It is understood that “first/second/third” can be used interchangeably if permitted. The specific order or sequence may be changed such that the embodiments of the present disclosure described herein can be implemented in an order other than that illustrated or described herein.

Unless otherwise defined, all technical and scientific terms used herein have the same meaning as commonly understood by those of ordinary skill in the art in the technical field to which the present disclosure belongs. The terminology used herein is for the purpose of describing the present disclosure only and does not intend to limit the scope of the present disclosure. The nouns and terms involved in the embodiments of the present disclosure will be first described. The nouns and terms involved in the embodiments of the present disclosure are applicable to the following explanations.

The present disclosure provides a control method, a control device, and an electronic device. During an image acquisition process of a first camera in the electronic device, the movement of the electronic device may be monitored based on sensing parameters of a motion sensor in the electronic device. In this way, when the sensing parameters satisfy a switching condition, it may be considered that a captured image obtained by the first camera cannot satisfy the actual needs, and the first camera may be switched to a second camera to obtain a second captured image, to ensure that continuous frame captured images that satisfy the actual needs are obtained. That is, the quality of the captured images may be guaranteed. In this process, a photographer may not need to manually select the camera switch, but automatic switching between different camera devices may be achieved directly based on the sensing parameters of the motion sensor, thereby improving the efficiency and reliability of acquiring captured images, better satisfying the different photographing needs of ordinary photographers with low professional skills in various photographing environments and photographing objects, and improving user experience.

At S12, sensing parameters are obtained through a motion sensor, where the sensing parameters are configured to characterize the movement of the electronic device and the motion sensor and the first camera belong to the same electronic device.

In the present disclosure, automatic switching control of different camera devices may be achieved according to the movement of the electronic device. Therefore, when the state of the photographing object changes, such as the moving speed or trajectory of the photographing object changes in the scene of video recording of competitive athletes, the electronic device may move or the movement of the electronic device following the photographing may change. When the first captured image obtained by the currently working first camera does not satisfy the actual requirements, the present disclosure hopes to quickly and accurately control other more suitable camera devices to continue to obtain the captured image to ensure the image quality.

In one embodiment, the sensing parameters may be obtained in real time or periodically (the period is often short) by the motion sensor in the electronic device, to determine the operating state of the electronic device through the continuous change of the sensing parameters, such as shaking movement or rotation or stable movement, etc. The present disclosure does not limit the content of the sensing parameters and the method of obtaining them. Preferably, in one embodiment, an IMU (Inertia Measurement Unit) inertial sensor may be configured to detect and measure one or more sensing parameters such as acceleration, tilt angle, vibration, rotation, or multi-degree-of-freedom movement of the electronic device in which it is located. In other embodiments, obtaining the sensing parameters may also be implemented by an acceleration sensor (i.e., an accelerometer that detects acceleration in different directions), an angular velocity sensor (such as a gyroscope that detects angular velocity in different directions) and/or other types of sensors. The present disclosure does not describe the motion sensor type and its working process in detail.

At S13, when the sensing parameters satisfy a switching condition, a second captured image is obtained by switching from the first camera to a second camera, where the second camera is different from the first camera.

In one embodiment, the switching condition for determining the switching between the first camera and the second camera may be related to the photographing parameters of the corresponding camera devices, such as one or more photographing parameters including photographing range, focus distance, or magnification, or may also be determined in combination with the actual task requirements for capturing images (such as the integrity, clarity, size/proportional relationship of the photographing object in the picture, etc.). The present disclosure does not limit the content of the switching condition.

The content of the sensing parameters obtained for different types of motion sensors may be different. The present disclosure may analyze one or more continuously obtained sensing parameters to determine the current movement status of the electronic device, such as the movement speed, the movement amplitude in different directions (which may be determined based on the angle between the main axis of movement of the electronic device and the coordinate axis in the world/image coordinate system, but is not limited to this representation), or the movement distance relative to the photographed object, etc. According to actual needs, the duration that the electronic device is in the movement status may also be counted to avoid the movement status occurring instantaneously or in a very short time and satisfying the switching condition to cause improper switching operations, thereby improving the reliability and accuracy of the automatic switching control of the camera devices.

In the above-mentioned process of analyzing the sensing parameters, the analysis results of the sensing parameters in the corresponding aspects may be obtained in combination with the content or the representation of the switching condition, to accurately and reliably determine whether the sensing parameters satisfy the switching conditions, thereby determining whether the first camera satisfy the corresponding task requirements or which camera device can satisfy the corresponding task requirements, etc. In this way, when the switching condition is met, the first camera may be switched to the second camera (i.e., the camera device that satisfies the task requirements) in a timely and accurate manner to obtain the second captured image that satisfies the task requirements.

In some embodiments, when the photographing range of the first camera and the second camera are different, the field of view angles of the obtained collected images may be different, that is, the FOV (field of view) of each camera device may be different. The FOV may represent the photographing range that the camera device is able to cover. The field of view angles of the photographing environments may be different. When the target photographing object exceeds the FOV, the camera device cannot photograph the target photographing object, and the target photographing object may not exist in the captured image. When the FOV is larger, the photographing range of the camera device may be larger and the photographing reliability of the target photographing object may be higher. For example, the FOV of the first camera may be about 30° (unit: degree), and the FOV of the second camera may be 90°˜120° or 60°˜90°, etc., such that the photographing range of the first camera is larger than the photographing range of the second camera. The present disclosure does not limit the FOV values of different camera devices, and the photographing range of the camera device is not limited to the expression of FOV.

When the switching condition represents that the photographing range is larger when the movement amplitude of the electronic device, a camera device with a larger photographing range may be selected to obtain the captured image when the movement amplitude of the electronic device is larger. In this way, by determining the movement amplitude of the electronic device through the sensing parameters, it may be possible to determine whether the photographed object exceeds the photographing range of the first camera based on the current movement amplitude of the electronic device. That is, because of the movement amplitude of the electronic device, the photographing range of the first camera may change accordingly in the photographing environment, such that the position information of the target photographed object in the first captured image (which may be represented by image coordinates or by the distance between it and the image boundary/center position, etc.) changes accordingly, which may even cause the target photographed object to exceed the photographing range of the first camera in the photographing environment, resulting in the first captured image not containing the target photographed object. In this movement of the electronic device, the target photographed object cannot be photographed by the first camera, and the switching condition may be met. The electronic device may automatically switch from the first camera to the second camera with a larger photographing range to obtain the second captured image, ensuring that the captured image contains the target photographed object.

For example, in one embodiment, the first camera may be a main camera device and the second camera may be an ultra-wide-angle camera device. Since the photographing range of the main camera device is smaller than that of the ultra-wide-angle camera device, in the process of obtaining the first captured image through the main camera device, when the movement amplitude of the electronic device is larger than the switching threshold determined by the sensing parameters, it may mean that the photographing range of the main camera device may be too small and the target object may not be captured. Or, because the position of the target object in the first captured image may be far from the center position, the first captured image cannot be processed into image data of the target object that satisfies the task requirements, etc. Therefore, a smooth switching method may be adopted to switch from the main camera device to the ultra-wide-angle camera device to obtain the second captured image, such as automatically starting the ultra-wide-angle camera device to obtain the second captured image and shutting down the main camera device, to ensure that the content of the continuous frame captured images are coherent and the image quality of the processed images is smooth.

Optionally, in some embodiments, in the case where the above switching condition is related to the photographing range, it may be determined based on the sensing parameters that the target object exceeds the photographing range of the first camera. For example, when the target object is too large and the first camera cannot capture the entire target object, it may be switched to the second camera with a larger photographing range to obtain the second captured image to ensure that the target object in each captured image is complete.

In some other embodiments, when the switching condition is related to other functional parameters of the camera device, referring to the above-mentioned analysis of the functional parameters such as the photographing range, the switching threshold for the information including the movement amplitude/speed of the electronic device in the corresponding switching condition may also be determined based on the difference between the first camera and the second camera in the functional parameters, and the correlation between the functional parameters and the movement of the electronic device, such as that the corresponding functional parameters or the changes are larger/smaller when the movement amplitude/speed is larger according to a certain rule. Therefore, during the acquisition of the first captured image through the first camera, the method for determining whether the movement amplitude/speed of the current electronic device reaches the switching threshold may be implemented based on the obtained sensing parameters to determine whether to switch from the first camera to the second camera to continue obtaining the captured image, to ensure that the acquired captured image satisfies the task requirements. The present disclosure does not limit the content of the switching condition and its configuration method, which can be determined according to the circumstances.

In actual applications, to ensure the reliability of the switching control between different camera devices, the above switching control may determine whether the sensing parameters continuously obtained within a preset time length satisfy the switching condition. The preset time length may be 3 s or 5 s, etc., and may be pre-configured according to actual task requirements or based on experience. The present disclosure does not limit the numerical configuration and adjustment method of the preset time length. The preset time length may be set when the switching condition is set. Of course, when the switching condition needs to be adjusted, the setting interface of the electronic device may be entered for adjustment.

For different task requirements, the above switching condition may be different. In one embodiment, when the electronic device is configured with multiple switching conditions corresponding to different types of tasks (i.e., tasks related to image acquisition), the corresponding target switching condition may be determined based on information such as the application type or application trigger function type or application output interface type of the first camera to be activated, such that in the process of obtaining the captured image, by determining whether the sensing parameters satisfy the target switching condition, the switching control between camera devices is realized to obtain the captured image through the switched target camera device. Optionally, it may also be possible to directly determine that the sensing parameters satisfy any switching condition, and switch from the first camera to the second camera corresponding to the switching condition to obtain the second captured image, etc.

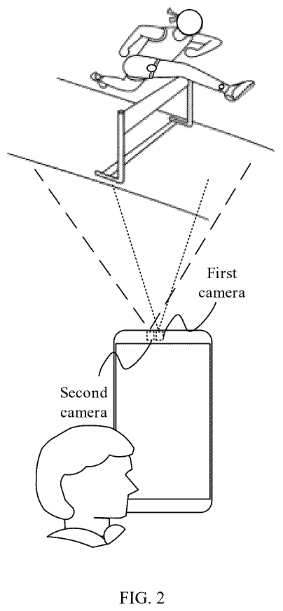

Preferably, in one embodiment shown in FIG. 2 which is a schematic diagram of an optional application environment architecture of the control method, the second camera may be a camera device that is deployed in the same electronic device where the first camera and the motion sensor are located and is different from the first camera. That is, the first camera, the second camera, and the motion sensor may be deployed in the same electronic device. In the process of obtaining the second captured image through the second camera, when the sensing parameters satisfy the corresponding switching condition, the first captured image may be obtained by switching from the second camera to the first camera. When the positional relationship between the first camera, the second camera and the target object is consistent, such as the fields of view are consistent (such as both are rear cameras of electronic devices, etc.), the image processing workload of the processing device configured to process the captured image may be reduced. For the processing scenario of the captured image, references may be made to the description of the corresponding part of the embodiments below, and this embodiment will not be described in detail here.

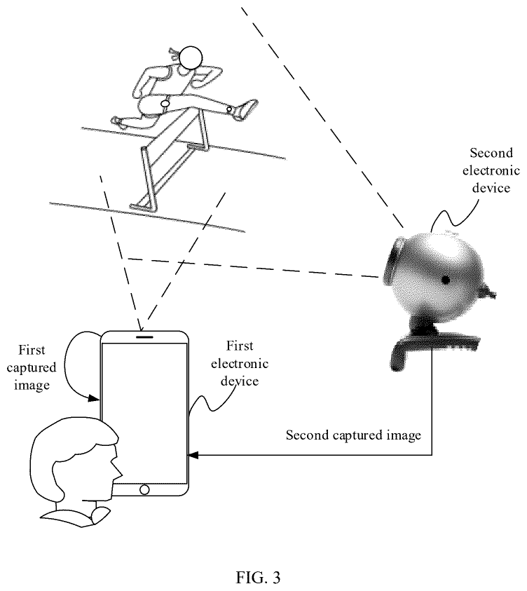

It can be understood that the second camera may also belong to a different electronic device from the first camera in some other embodiments. In this case, for the convenience of description, the first camera or the electronic device where it is located may be referred to as the first electronic device, and the second camera or the electronic device where it is located may be referred to as the second electronic device. In this embodiment, as shown in FIG. 3 which is another optional application environment architecture diagram of the control method, through communication between the first electronic device and the second electronic device, when the first electronic device determines that the sensing parameters obtained by the motion sensor satisfy the switching condition, a second camera control instruction may be sent to the second electronic device, and the second camera may start to perform image acquisition. The second captured image captured by the second camera may be received. When the second camera is in the image acquisition state, the second captured image captured by the second camera may be transmitted to the first electronic device, and the original processing task of the second electronic device on the second captured image may not be affected.

The embodiment shown in FIG. 3 with the application scenario in which the first electronic device and the second electronic device are configured to acquire images is used as an example only to illustrate the present disclosure, and does not limit the scope of the present disclosure. The present disclosure does not limit the product types of the first electronic device and the second electronic device. The embodiment shown in FIG. 3 in which the second camera and the first camera belong to different electronic devices is used as an example only to illustrate the present disclosure, and does not limit the scope of the present disclosure. In this control system, since the external parameters and the internal parameters of the first electronic device and the second electronic device may be different, the field of view/angle, etc. of the target object in the captured images obtained by each may be different. As shown in FIG. 3, the two camera devices may respectively acquire images from different sides of the target object, such that the captured images obtained by each may display different surface features of the target object and the field of view of the presented photographing environment may be also different.

To obtain continuous frame images with smooth image quality and coherent content, in one embodiment, the positional relationship between the first electronic device and the second electronic device may be fixed. And, when the fields of view of the captured images obtained by the first electronic device and the second electronic device have a high degree of overlap, the first camera and the second camera may both be in the image acquisition state, and the captured images obtained by the two camera devices may be obtained. The processing device (which may be located in the first electronic device or a third electronic device) may extract the image features of the first captured image and the second captured image, and generate an image descriptor through a computer vision algorithm to characterize each object in the image, that is, to describe the distribution of feature points of the first captured image. After that, image registration, correction, splicing, or other fusion processing may be achieved through feature matching or homography matrix estimation, such that the position of the target photographing object in the image in the obtained fused image is basically unchanged, that is, the FOV of each frame image is consistent (such as the field of view angle/range is consistent or the change is less than a threshold), to achieve an anti-shake effect. The image fusion processing process may also be combined with other processing task requirements to make the obtained fused image satisfy the processing task requirements. The present disclosure does not limit the implementation method of the fusion of the above two image data streams, and a suitable deep learning/machine learning algorithm may also be selected to improve the image processing efficiency and ensure the quality of the obtained image.

In some embodiments, in the case where the relative position relationship between the first camera and the second camera changes, the real-time position relationship between the two may be determined based on the sensing parameters obtained by the sensors in the respective electronic devices. Therefore, the alignment, correction or replacement, splicing or other fusion processing of the feature points in the second captured image of the frame may be achieved based on the real-time position relationship, the respective internal parameters (calibration parameters) or other information, the distribution of feature points extracted from the first captured image of the current frame, and the distribution of feature points extracted from the second captured image, with reference to but not limited to the image fusion method described in the previous paragraph, such that the second output image generated thereby is consistent with the position of the target photographing object in the first output image corresponding to the first captured image of the previous frame. The first captured image may be replaced based on the fused image of the frame, and the next frame of the second captured image may be processed to achieve the anti-shake effect.

In one embodiment, the captured image obtained by the target camera device (the first camera or the second camera) may be directly stored in its own storage device such that other devices may obtain the stored captured image for processing according to the actual processing task requirements. In some other embodiments, the captured image obtained by the target camera device may also be transmitted to the target processing engine of the electronic device (which serves as the above-mentioned processing device) for processing. To ensure the reliability of the processing results of the target processing engine on the acquired captured image and satisfy the corresponding processing task requirements, the sensing parameters obtained by the motion sensor in the electronic device may need to be provided to the target processing engine. Before providing the sensing parameters to the target processing engine, it may be necessary to first execute the control method described in any embodiments and switch from the first camera to the second camera to obtain the second captured image when the sensing parameters satisfy the switching conditions. This step may ensure that the sensing parameters currently provided to the target processing engine are the same sensing parameters that satisfy the switching condition, such that the target processing engine processes the captured image obtained by the target camera device based on the sensing parameters, which is the second captured image obtained by the second camera here.

Similarly, in the case of switching back from the second camera to the first camera, the control may also be performed according to the method described above. For example, when the sensing parameters obtained by the motion sensor satisfy the corresponding switching condition, the first captured image may be obtained by switching from the second camera to the first camera, and the sensing parameters may be provided to the target processing engine to process the first captured image obtained by the first camera based on the sensing parameters. There may be a correlation between the captured image and the sensing parameters required by the target processing engine as described above. In the process of obtaining the captured image through the target camera device, the sensing parameters obtained by the motion sensor may be directly provided to the target processing engine to realize the processing of the captured image. When the camera device needs to be switched at present, the sensing parameters that satisfy the switching condition may be determined, and, after switching to the target camera device to obtain the captured image, the sensing parameters may be provided to the target processing engine to process the captured image obtained from the switched target camera device.

In some embodiments, in photographing scenarios such as video recording, the operator may be required to operate the electronic device to move, and even the target object may move in the photographing environment, which may easily cause the captured image directly obtained by the camera to have problems such as jitter (such as the position of the target object in the captured image changes greatly, and the position movement trajectory in the continuous frame captured image is a movement curve) and blur. Especially, when the photographing distance between the target object and the camera device is close and the relative movement amplitude of the target object in the photographing environment is large, the jitter of the target object in the captured image may be more obvious.

To obtain video data with a basically stable display position of the target object in continuous frame images and smooth image quality, the target processing engine may execute the electronics image stabilization (EIS) algorithm to process the captured image obtained by the target camera device based on the sensing parameters obtained by the motion sensor, such as determining various correction/compensation parameters or other anti-shake parameters that match the target camera device (different camera devices may be distinguished by identifiers such as the target camera ID), or dynamically adjusting the ISO sensitivity, shutter speed or imaging algorithm of the captured image from the target camera device to correct image blur in combination with the currently obtained sensing parameters. Also, to ensure that the field of view angle/range of the target object is stable when photographing videos/pictures, such as to make the target object located at the center of the viewfinder (i.e., the image stabilization position, but not limited to the center position), the image stabilization parameters obtained from different camera devices may be obtained. In the case of different captured image sizes and field of view, before performing cropping processing based on the display position of the target object, the small-sized captured image may be enlarged and then cropped to obtain a cropped image of a preset image size, thereby reducing or eliminating the image black edge problem and making the FOV for the target object consistent in each processed frame image (such as the image in the viewfinder). The working principle of the EIS algorithm, i.e., the implementation method of the electronic image stabilization processing of the image, will not be described in detail here, and it is not limited to the processing method described in the context of the present disclosure. The target processing engine may also continue to perform image quality compensation on the image after electronic image stabilization processing based on actual image quality requirements in combination with other image processing algorithms to improve image quality.

In practical applications, since different camera devices may have different camera extrinsic parameters or intrinsic parameters (such as calibration parameters), the captured images from different camera devices may differ in at least one dimension, such as image size, image resolution or other quality parameters, or field of view angle/range. Further, these dimensional data may cause the camera device located in the electronic device to move synchronously due to the movement of the electronic device, causing its extrinsic parameters to change. To obtain high-quality images, the user who views the processed continuous frame images may be prevented from perceiving the switching process of the camera device as much as possible, and the difference between two adjacent frames of images from different camera devices may be reduced. The target processing engine may implement electronic anti-shake processing of the captured image based on the camera extrinsic parameters and intrinsic parameters of the target camera device (the first camera or the second camera that currently provides the captured image to the target processing engine) and the sensing parameters obtained by the motion sensor, to obtain the corresponding frame image that satisfy the anti-shake requirements.

For the above-mentioned anti-shake parameters such as camera external parameters and internal parameters used for the captured images obtained by different camera devices, the target processing engine may associate them with the camera identifier of the corresponding camera device and store them. Therefore, when processing the captured image obtained by the target camera device, the anti-shake parameters matching the camera identifier of the target camera device may be directly determined. For example, the captured images may carry the camera identification and may be transmitted to the target processing engine. The target processing engine may also determine the anti-shake parameters matching the target camera device based on the size or field of view of the received captured images. The captured images from the target camera device may be processed based on the anti-shake parameters and the received sensing parameters. To ensure that the viewing angle range or FOV angle of the processed images corresponding to different camera devices is consistent, the target cropping parameters in each anti-shake parameter may be the same, and the target cropping parameter may represent the position relationship of the target photographing object in the cropped image or the FOV for the target photographing object.

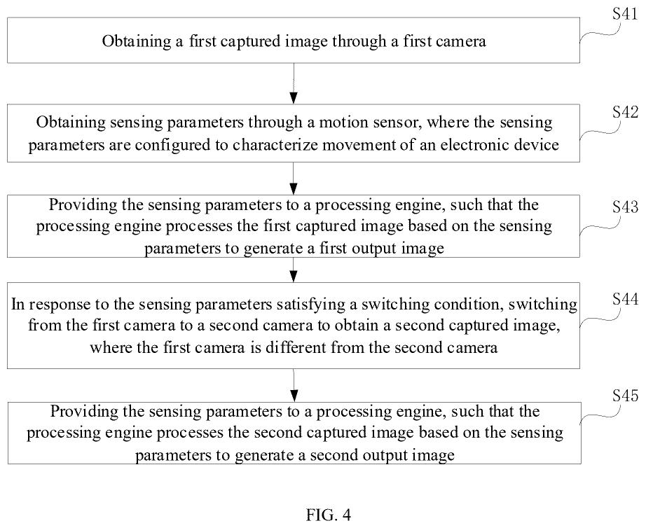

In one embodiment, as shown in FIG. 4, which is a flow chart of another control method, the functions of the target processing engine are described in detail but are not limited to the functions described in this embodiment. As shown in FIG. 4, the method may include but is not limited:
S41, obtaining a first captured image through a first camera;
S42, obtaining sensing parameters through a motion sensor, where the sensing parameters are configured to characterize the movement of the electronic device, and the motion sensor and the first camera belong to the same electronic device; and
S43, providing the sensing parameters to the target processing engine, where the target processing engine processes the first captured image based on the motion sensor to generate a first output image.

In the present embodiment, the target processing engine may process the captured image based on the captured image obtained by the target camera and the sensing parameters obtained by the motion sensor, to generate an output image. When the first camera is the target camera device, the first captured image may be transmitted to the target processing engine. The target processing engine may process the first captured image based on the corresponding sensing parameters to generate the output image, such as encoding and decoding the image after electronic image stabilization processing to obtain an image data stream that satisfies the output requirements of the captured image, and transmit it to other electronic devices for image processing, storage or playback of other tasks, etc., or transmit it to a storage device in the electronic device where the target processing engine is located for storage, or a display for synchronous display, etc. The present disclosure does not limit the method for generating the output image.

Preferably, in one embodiment, the camera of the first camera may have an OIS (optical image stabilization) anti-shake function. That is, in the camera, the optical components, such as the lens settings, may be set to avoid or reduce the instrument shaking phenomenon in the process of capturing optical signals, such that optical image stabilization is achieved. For example, a small movement may be detected through the gyroscope in the lens, and then the signal may be transmitted to the microprocessor, such that the microprocessor immediately calculates the displacement to be compensated and then compensates according to the shaking direction and displacement of the lens through the compensation lens group, to overcome the image blur problem caused by the vibration of the camera. The OIS anti-shake function may correct the optical axis offset through the floating lens of the lens. The OIS anti-shake effect of the camera device determined by the structure may be determined. The first captured image obtained by the first camera may be an image after OIS anti-shake processing, and there may be no need to continue to perform electronic anti-shake processing on the first captured image by the target processing engine based on actual anti-shake requirements. The implementation process is not described in detail in this embodiment.

Based on this, when the second captured image is obtained through the second camera, the exposure parameters of the second camera, such as exposure time, etc., may be used. When the exposure time is too long, the second captured image may be blurred, indicating that the anti-shake processing effect of the second captured image by only the electronic anti-shake algorithm is not good. The first camera may be switched to obtain the first captured image, to realize the anti-shake processing of the first captured image through the two anti-shake methods of electronic anti-shake and optical anti-shake, improving the anti-shake effect of the obtained image and the output image quality.

The method may further include:
S44, when the sensing parameters obtained by the motion sensor satisfy the switching condition, switching from the first camera to the second camera to obtain the second captured image, where the second camera is different from the first camera; and
S45, providing the sensing parameters to the target processing engine, such that the target processing engine processes the second captured image based on the sensing parameters to generate a second output image.

During the process of the target processing engine processing the first captured image, when the first camera is used as the target camera device and the sensing parameters satisfy the switching condition, the second camera may be used as the target camera device, such that the second captured image obtained by the second camera may be processed based on the sensing parameters received at this time to generate an output image, such as performing electronic anti-shake processing on the second captured image based on the anti-shake parameters matched by the second camera and the sensing parameters currently obtained (which satisfy the switching condition for indicating switching to the second camera to provide the second captured image), and then encoding and decoding the image after the electronic anti-shake processing to obtain the second output image, which is not limited to the output image generation method described in above embodiments.

In the present disclosure, when obtaining the first captured image through the first camera, the first captured image of the current frame may be transmitted to the target processing engine, and after the processing method described in the corresponding part above, the first output image corresponding to the first captured image of the frame may be generated. During this period, the sensing parameters may be obtained through the motion sensor, and it may be determined whether the sensing parameters satisfy the switching condition. The second camera may be used as the target camera device, and the second captured image obtained by the second camera may continue to be transmitted to the target processing engine. The switching control process may not affect the target processing engine receiving the first captured image, and the obtained second captured image may replace the next frame of the first captured image and may be sent to the target processing engine to avoid video freeze caused by frame loss.

To facilitate the operator or other users to intuitively understand the processing effect of the target processing engine processing each frame of the captured image, based on the control method described in the above embodiments, in some embodiment, the output image generated by the target processing engine may be displayed. The present disclosure does not limit the display mode and time of the output image, such as synchronous display during the image acquisition process, or displaying each frame of the output image after the image acquisition is completed.

In one embodiment in which the target processing engine executes the electronic anti-shake algorithm to process the captured image to generate the output image, the target processing engine may receive the first captured image from the first camera and generate the first output image accordingly. When receiving the second captured image from the second camera, the target processing engine may generate the second output image accordingly. The multi-frame order of each first output image and each second output image may be consistent with the multi-frame order of the first captured image and the second captured image. For the process, the references may be made to the description of the corresponding part of the above embodiments, and this embodiment will not be repeated here.

When the target photographing object included in any frame of the first output image is located at the first position of the first output image of the frame, and the target photographing object included in any frame of the second output image is located at the second position of the second output image of the frame, when it is necessary to display the continuous frame output images (which may include the first output image and the second output image) generated by the target processing engine, when the first output image is displayed through the display screen, the first position of the target photographing object may be the same as the second position of the target photographing object when the second output image is displayed through the display screen, that is, the difference between the first position and the second position may be less than the threshold (a decimal value close to zero), and it may be considered that after the target processing engine performs electronic anti-shake processing on the first captured image and the second captured image, the corresponding output image obtained achieves an anti-shake effect, that is, the position of the target photographing object in the generated continuous frame output images relative to the display screen is the same, to achieve an image stabilization effect on the target photographing object, and the above-mentioned first position and second position may be the image stabilization positions described above.

For example, in a skiing photographing scene shown in FIG. 5, a skier is taken as the target photographing object, and the electronic device is operated to follow the skier to collect images. The skier's movement trajectory is often irregularly curved, and its movement amplitude also changes irregularly. The electronic device that follows and photographs also moves with the skier, and its movement amplitude is often inconsistent with the skier's movement amplitude change. The movement speeds of the two may also be different, causing the skier to exceed the photographing range of the first camera currently used by the electronic device such that the skier does not exist in the first captured image. The actual photographing requirements are not satisfied. To avoid this situation, according to the control method provided by the present disclosure, the sensing parameters obtained in real time by the motion sensor in the electronic device may characterize the movement of the electronic device. By analyzing and determining that the movement amplitude of the electronic device satisfies the switching condition, it may be indicated that the first camera cannot satisfy or will not satisfy the photographing requirements, and the skier will exceed the photographing range or the distance from the photographing range boundary is not enough to support the image processing of the target processing engine, that is, for the position of the target photographing object in the first captured image obtained by the current first camera, the cropping space reserved for the target processing engine is not enough to solve the jitter problem, and the anti-shake effect is poor. It may be switched to the second camera with a larger photographing range that supports the better anti-shake effect to obtain the second captured image. For the switching control process and the electronic anti-shake processing process, references may be made to the description of the corresponding part of the above embodiments, and this embodiment will not be described in detail here.

Through the control method provided by the present disclosure, the target photographing object in the output image corresponding to the captured images of different cameras displayed by the electronic device may be located in the same position in the output image. As shown in FIG. 5, a, b and c show the output images corresponding to the captured images of different cameras, which may ensure that the skier is always in the center of the display screen, but is not limited to the image stabilization position.

It is understandable that in scenes such as filming of movies or TV series, the electronic device where the first camera is located may be deployed on a mobile device that is able to move along a fixed moving track, and the electronic device may move synchronously with the mobile device, such that the first camera may not shake in the vertical direction. Without considering that the target object exceeds the photographing range in the vertical direction, the difference between the moving speed of the first camera and the moving speed of the target object may be larger than the switching threshold. When the first camera moves too slowly, it may also cause the target object to exceed the photographing range in the horizontal direction. In this case, it may also be switched to the second camera with a larger photographing range to obtain the second captured image, such that the target object does not exceed the photographing range of the target camera device and the target processing engine is able to reliably complete the processing task, to ensure that the position of the target object in the continuous frame image in the shot video is the same.

When capturing images of target objects with a large moving speed, it may be possible to switch to a camera device with a large photographing range to obtain the captured image. For target objects with a small moving speed, without considering resource consumption, it may also be possible to use a camera device with a large photographing range to obtain the captured image. When it is necessary to achieve energy saving at the same time, it may be possible to choose to switch to a camera device with a small photographing range to obtain the captured image, as long as the obtained captured image is sufficient for finishing the subsequent processing tasks.

It should be noted that the applicable scenarios of the control method provided by the present disclosure may include but are not limited to the several photographing scenes listed above, and may also be other extreme sports scenes, or animal photographing scenes, or full-movement object photographing scenes, etc. The implementation method of switching control on different camera devices to obtain captured images that satisfy the task processing requirements is similar, and the present disclosure does not give detailed examples one by one.

For the scenarios described in the above embodiments where the output image needs to be displayed, such as in the video recording scenario, the first captured image obtained by the first camera and the second captured image obtained by the second camera may belong to the captured images in the same recording process. That is, in the video recording process, the switching control between the first camera and the second camera may not affect the video recording, and there may be no need to exit the video recording and switch to the target camera device for video recording. For the user, the switching between different camera devices may be basically imperceptible, which improves the user experience.

In one embodiment, when the control method provided by the present disclosure is applicable to the above-mentioned image recording (such as video recording or multi-frame picture photographing) scenario, the first output image and the second output image may belong to the storage image of the target file generated in the same recording process. In this case, the control method may be configured to complete this video recording, and the output image generated by the target processing engine may be directly stored as the storage image of the target file, that is, stored according to the storage path of the target file. The process may not need to display the output image.

In another embodiment, during the image recording process applicable to the control method provided by the present disclosure, such as the photographing scene shown in FIG. 5, the image preview function may be started, and the output image generated by the target processing engine may be provided to the display screen as a preview image, that is, the first output image and the second output image may belong to the preview image provided to the display screen during the same recording process. In this way, during the image recording process, while processing the captured image to generate the output image, the generated output image may be synchronously displayed on the display screen of the electronic device, such that the operator is able to intuitively view the processing effect of the output image, such as the anti-shake effect. When the processing effect is not good, it may be manually switched to a more suitable other camera device to obtain the captured image to improve the processing effect of the corresponding output image. The implementation of manually switching the target camera device is not limited in the present disclosure, such as by performing touch operations including magnification or focus adjustment on the reserved image displayed on the display screen, or by voice commands or preset gesture operations, etc., to trigger the corresponding switching conditions to switch to the target camera device to obtain the captured image, etc.

It can be understood that in the control method described in each embodiment above, after switching from the first camera to the second camera to obtain the captured image, the control method may still be configured to determine whether the sensing parameters obtained by the motion sensor satisfy the switching conditions for indicating switching to the first camera to obtain the first captured image, and the first captured image may still be obtained by switching from the second camera to the first camera. Of course, when there are more camera devices, the corresponding switching conditions may also be configured according to this control method. In this way, when the sensing parameters satisfy the corresponding switching condition, the captured image may be obtained by switching from the currently used camera device to the target camera device corresponding to the switching condition. For the switching condition content and the switching control method, references may be made to the description of the corresponding part of the above embodiments, and this embodiment will not be repeated here.

Preferably, in some embodiments, to avoid frequent switching between different camera devices, the above-mentioned sensing parameters satisfying the switching condition may be that the sensing parameters continuously obtained within the preset time length all satisfy the switching condition, or the average sensing parameters obtained within the preset time length satisfy the switching condition, and the camera device switching control may be executed correspondingly, such that the first camera switches to the second camera to obtain the second captured image, or the second camera switches to the first camera to obtain the first captured image. Therefore, the control mode of directly executing the switching control when the sensing parameters obtained at a certain moment or in a very short time (such as a short jitter when the operator holds the electronic device to photograph, such as 1s, etc.) satisfy the switching condition, since it is easy to cause frequent switching between different camera devices, resulting in waste of resources, which may increase the calculation amount of the target processing engine to process the captured image, reduce the output image quality, and other problems. In the image recording scene, it may also cause the obtained image to freeze, affecting the user experience.

Therefore, a larger switching threshold may be configured in the switching condition based on which switching to the second camera with a larger photographing range is performed, and a smaller switching threshold may be configured in the switching condition based on which switching to the first camera with a smaller photographing range is performed. Therefore, when the photographing range of the first camera is smaller than the photographing range of the second camera, the above S13 may include:
based on the sensing parameters obtained by the motion sensor, determining the movement amplitude of the electronic device; and, when the average movement amplitude of the electronic device within the preset time is larger than the first switching threshold, switching from the first camera to the second camera to obtain the second captured image. Afterwards, when the average movement amplitude of the electronic device within the preset time is less than the second switching threshold, the first captured image may be obtained by switching from the second camera to the first camera. At this time, the high-energy-consuming second camera may no longer be configured to obtain the second captured image. The second switching threshold may be smaller than the first switching threshold. The present disclosure does not limit the values of these two switching thresholds, which may be configured or selected according to the actual photographing scene.

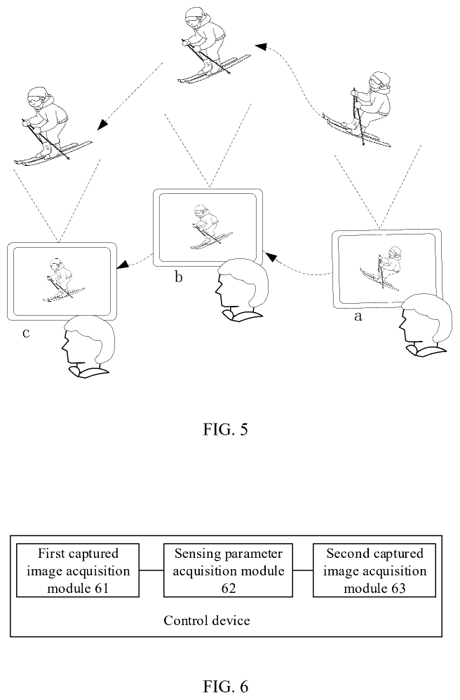

The present disclosure also provides a control device. As shown in FIG. 6, which is a schematic diagram of a structure of a control device, the control device may be applied to an electronic device. As shown in FIG. 6, the control device may include:
a first captured image acquisition module 61, configured to obtain a first captured image through a first camera;
a sensing parameter acquisition module 62, configured to obtain sensing parameters through a motion sensor, where the sensing parameters are configured to characterize the movement of the electronic device; and
a second captured image acquisition module 63, configured to switch from the first camera to the second camera to obtain a second captured image when the sensing parameters satisfy a switching condition.

The first camera and the motion sensor may belong to the same electronic device, and the first camera may be different from the second camera.

In some embodiments, the photographing ranges of the first camera and the second camera may be different. In this case, the above switching condition may be related to the photographing range. For example, the switching condition may characterize that the photographing range is larger when the movement amplitude of the electronic device is larger. In this way, it may be determined whether to switch to a camera device with a larger photographing range to obtain a captured image by judging whether the movement amplitude of the electronic device is large enough to cause the target photographing object to exceed the photographing range of the current camera device. Alternatively, when the movement amplitude is small, to reduce energy consumption, it may be selected to switch to a camera device with a smaller photographing range to obtain a captured image. For the control process, references may be made to the description of the corresponding part of the above embodiments.

Optionally, the control device may further include:
a sensing parameter transmission module, configured to provide the sensing parameters to the target processing engine, where the target processing engine is configured to process the captured image obtained by the target camera device based on the sensing parameters.

When the sensing parameters satisfy the switching conditions, switching from the first camera to the second camera to obtain the second captured image may be performed before providing the sensing parameters to the target processing engine.

Based on this, in some embodiments, the target processing engine may process the captured image to generate an output image based on the captured image obtained by the target camera device and the sensing parameters obtained by the motion sensor. When the first camera is used as the target camera device and the sensing parameters satisfy the switching conditions, the second camera may be controlled to be used as the target camera device. The first captured image may correspond to the first output image, and the second captured image may correspond to the second output image.

Optionally, the control device may further include:
a display module for displaying the output image.

The target photographing object included in the first output image may be located at the first position of the first output image, and the target photographing object included in the second output image may be located at the second position of the second output image. The first position of the target photographing object when displaying the first output image may be the same as the second position of the target photographing object when displaying the second output image.

Optionally, when the first captured image and the second captured image belong to the captured images in the same recording process, the first output image and the second output image may belong to the storage images of the target file generated in the same recording process, that is, the recording image storage is realized. Of course, in some other embodiments, the first output image and the second output image may belong to the preview images provided to the display screen for display in the same recording process, to realize the preview display of the recorded image.

In one embodiment, when the photographing range of the first camera is smaller than the photographing range of the second camera, the above second captured image acquisition module 63 may include:
a movement amplitude determination unit, configured to determine the movement amplitude of the electronic device based on the sensing parameters; and
a first switching control unit, configured to switch from the first camera to the second camera to obtain the second captured image when the average movement amplitude of the electronic device within the preset time is larger than the first switching threshold.

Based on this, the above control device may also include:
a first camera switching control device, configured to switch from the second
camera to the first camera to obtain the first captured image when the average movement amplitude of the electronic device within the preset time is less than the second switching threshold.

The second switching threshold may be less than the first switching threshold.

It should be noted that the various modules, units, etc. in the above-mentioned control device embodiments may be stored in the memory as program modules, and the processor may execute the above-mentioned program modules stored in the memory to implement the corresponding functions. For the functions implemented by each program module and its combination, as well as the technical effects achieved, references may be made to the description of the corresponding parts of the above-mentioned method embodiments, which will not be repeated in this embodiment.

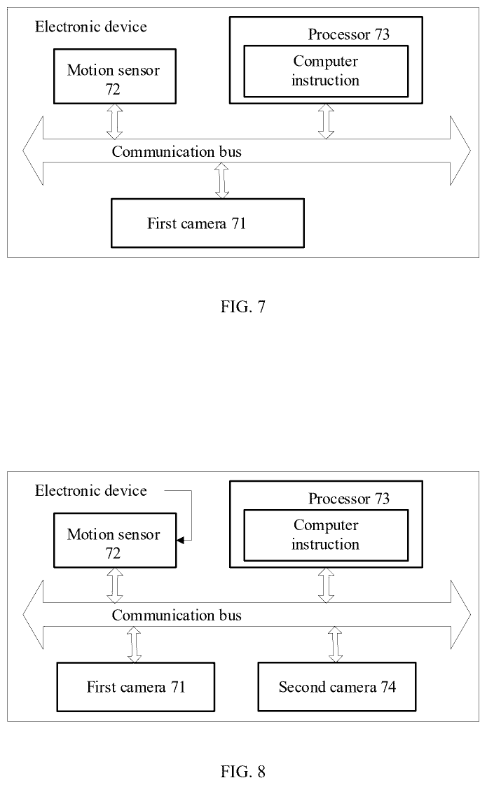

The present disclosure also provides an electronic device. In one embodiment, as shown in FIG. 7 which is a schematic diagram of the hardware structure of an electronic device consistent with the embodiments of the present disclosure, the electronic device may include: a first camera 71, a motion sensor 72, and a processor 73 connected to the first camera 71 and the motion sensor 72, respectively. It is understood that the structure illustrated in the embodiment of the present disclosure does not constitute a specific limitation on the electronic device. In other embodiments of the present disclosure, the electronic device may include more or fewer components than shown in the figure, or combine certain components, or split certain components, or arrange the components differently. The components shown in the figure may be implemented in hardware, software, or a combination of software and hardware. FIG. 7 is only an example of the structure of the electronic device implementing the control method.

The first camera 71 may be configured to obtain a first captured image.

In one embodiment of the present disclosure, the first camera 71 may be a camera of any type or function. When divided into cameras of different focal lengths according to the focal length, the camera devices may include ultra-wide-angle cameras, wide-angle cameras, or telephoto cameras, etc., in the order of the equivalent focal length from small to large. A camera with a smaller equivalent focal length may have a larger field of view/photographing range, and a camera with a larger equivalent focal length may have a smaller field of view/photographing range. The first camera may include any of the cameras, or a depth camera for measuring the object distance of the target object, etc. The type of the first camera and its functional parameters, the photographing scene used, etc. may be determined according to the actual photographing needs. Of course, the electronic device may also include more types and numbers of camera devices, which may be deployed according to the actual photographing needs. The present disclosure does not limit the number and type of camera devices contained in the electronic device and their deployment locations.

The motion sensor 72 may be configured to obtain sensing parameters, and the sensing parameters may be configured to characterize the movement of the electronic device. Combined with the above analysis, the sensing parameters obtained by different types of motion sensors 72 may be different. In one embodiment of the present disclosure, the motion sensor 72 may include but is not limited to a pressure sensor, a gyroscope sensor, an air pressure sensor, a magnetic sensor, a speed sensor, an acceleration sensor, a distance sensor, a proximity light sensor, a fingerprint sensor, a temperature sensor, a touch sensor, an ambient light sensor, an inertial sensor, etc., which may be determined according to the functional requirements of the electronic device.

The processor 73 may be configured to load and execute computer instructions to implement the control method provided by various embodiments of the present disclosure, including: obtaining the first captured image and the sensing parameters; when the sensing parameters satisfy the switching condition, obtaining the second captured image by switching from the first camera 71 to the second camera 74. The second camera 74 may be different from the first camera 71, and may be any camera device listed above that is different from the first camera. The second camera may belong to the same electronic device as the first camera, and may be deployed in the electronic device proposed to obtain the structure shown in FIG. 8.

Optionally, in some other embodiments, the second camera 74 may also be deployed in a second electronic device that is connected to the electronic device for communication, as shown in the photographing scene shown in FIG. 3. The present disclosure does not limit the product type of each electronic device. In this case, the electronic device may further include a communication module for realizing communication connection with the second electronic device, such as a wireless communication module such as WIFI, Bluetooth or 5G/6G, and may also include a wired communication module, such as a connection through a data transmission line, etc., which may be determined according to the photographing requirements of the two electronic devices.

The processor 73 may include one or more processing units. In practical applications, the processor 73 may include but is not limited to a central processing unit (CPU), an application processor (AP), a modem processor, a graphics processing unit (GPU), an image signal processor (ISP), a video codec, a digital signal processor (DSP), a baseband processor, a neural-network processing unit (NPU), an application-specific integrated circuit (ASIC), a field programmable gate array (FPGA), or any one or more other programmable logic devices. Different processing units may be independent devices or integrated into one or more processors.

Optionally, a memory may also be provided in the processor 73 for storing the computer instructions, captured images, output images generated by the target processing engine, or other data generated or used during the execution of the control method. The memory may include but is not limited to random access memory, flash memory, read-only memory, programmable read-only memory or electrically erasable programmable memory, registers or other storage media, etc. The information in the storage medium may be read by hardware, and the control method provided by various embodiments of the present disclosure may be implemented in combination with the hardware in the electronic device. To avoid repetition, this embodiment is not described in detail here.

In some embodiments, in combination with the above analysis, the electronic device may also include a display screen for displaying the output image. The display screen may include a display panel, such as one or more of a touch-sensitive display panel, a liquid crystal display panel, or various diode display panels. The present disclosure does not limit the number and type of display screens in the electronic device.

It should be understood that the structure of the electronic device shown in FIG. 7 and FIG. 8 does not constitute a limitation on the electronic device provided by the present disclosure. In practical applications, the electronic device may include more or fewer components than those shown in the accompanying drawings, or combine certain components, such as at least one input component such as a keyboard, a pickup, etc.; at least one output component such as a speaker, a vibration mechanism, a lamp, etc.; an antenna; a power module, etc., which may be determined in combination with control requirements, and the present disclosure does not list them one by one here.

The present disclosure also provides a computer-readable storage medium, on which multiple computer instructions are stored. The computer instructions may be loaded and executed by a processor to implement the control method provided by various embodiments of the present disclosure. The implementation process is not repeated in this embodiment.

The present disclosure also provides a computer program product, including a computer program/instructions, which is executed by a processor or other hardware to implement the control method provided by various embodiments of the present disclosure. The implementation process can refer to the description of the corresponding method embodiment above.

Each embodiment in this specification is described in a progressive mode, and each embodiment focuses on the difference from other embodiments. Same and similar parts of each embodiment may be referred to each other. As for the device disclosed in the embodiments, since it corresponds to the method disclosed in the embodiments, the description is relatively simple, and for relevant details, the reference may be made to the description of the method embodiments.

Units and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, region or substrate is referred to as being “on” another element, it may be directly on the another element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is said to be “connected” to another component, it may be directly connected to the other component or there may be an intermediate component present at the same time.

It should also be noted that in this article, relational terms such as “first” and “second” are only configured to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element associated with the phrase “comprises a . . . ” or “includes a . . . ” does not exclude the presence of other identical elements in an article or device that includes the above-mentioned element.

The disclosed equipment and methods may be implemented in other ways. The device embodiments described above are only illustrative. For example, the division of the units is only a logical function division. In actual implementation, there may be other division methods, such as: multiple units or components may be combined, or can be integrated into another system, or some features can be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to multiple network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units can be integrated into one unit. The above-mentioned integration units can be implemented in the form of hardware or in the form of hardware plus software functional units.

All or part of the steps to implement the above method embodiments may be completed by hardware related to program instructions. The aforementioned program may be stored in a computer-readable storage medium. When the program is executed, the steps including the above method embodiments may be executed. The aforementioned storage media may include: removable storage devices, ROMs, magnetic disks, optical disks or other media that can store program codes.

When the integrated units mentioned above in the present disclosure are implemented in the form of software function modules and sold or used as independent products, they may also be stored in a computer-readable storage medium. Based on this understanding, the technical solutions of the embodiments of the present disclosure in essence or those that contribute to the existing technology may be embodied in the form of software products. The computer software products may be stored in a storage medium and include a number of instructions for instructing the product to perform all or part of the methods described in various embodiments of the present disclosure. The aforementioned storage media may include: random access memory (RAM), read-only memory (ROM), electrical-programmable ROM, electrically erasable programmable ROM, register, hard disk, mobile storage device, CD-ROM, magnetic disks, optical disks, or other media that can store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A control method, performed by an electronic device, comprising:
obtaining a first captured image through a first camera;
obtaining sensing parameters through a motion sensor, wherein the sensing parameters are configured to characterize movement of an electronic device; and
in response to the sensing parameters satisfying a switching condition, switching from the first camera to a second camera to obtain a second captured image, wherein the first camera and the motion sensor belong to the same electronic device, and the first camera is different from the second camera.

2. The method according to claim 1, wherein:
photographing ranges of the first camera and the second camera are different;
the switching condition is related to the photographing range; and
the switching condition indicates that the photographing range is larger when the movement amplitude of the electronic device is larger.

3. The method according to claim 1, further including:
providing the sensing parameters to a processing engine, wherein:
the processing engine is configured to process a captured image obtained by a target camera device based on the sensing parameters;
when the sensing parameters satisfy the switching condition, switching from the first camera to the second camera to obtain the second captured image is performed before providing the sensing parameters to the processing engine.

4. The method according to claim 3, wherein:
the processing engine is configured to: based on the captured image obtained by the target camera device and the sensing parameters obtained by the motion sensor, process the captured image to generate an output image,
wherein:
when the first camera serves as the target camera device and the sensing parameters satisfy the switching condition, the second camera is controlled to serve as the target camera device;
the first captured image corresponds to a first output image; and
the second captured image corresponds to a second output image.

5. The method according to claim 4, further including:
displaying the output image,
wherein:
a target object included in the first output image is located at a first position of the first output image;
the target object included in the second output image is located at a second position of the second output image; and
the first position of the target object when displaying the first output image is the same as the second position of the target object when displaying the second output image.

6. The method according to claim 5, wherein:
the first captured image and the second captured image are captured images during a same recording process; and
the first output image and the second output image are storage images of a target file generated during the same recording process; or the first output image and the second output image are preview images provided to a display screen for display during the same recording process.

7. The method according to claim 2, wherein:
when the photographing range of the first camera is smaller than the photographing range of the second camera, in response to the sensing parameters satisfying the switching condition, switching from the first camera to the second camera to obtain the second captured image includes:
determining the movement amplitude of the electronic device based on the sensing parameters;
when the average movement amplitude of the electronic device within a preset time period is larger than a first switching threshold, switching from the first camera to the second camera to obtain the second captured image;
when the average movement amplitude of the electronic device within the preset time period is less than a second switching threshold, switching from the second camera to the first camera to obtain the first captured image, wherein the second switching threshold is smaller than the first switching threshold.

8. An electronic device, comprising:
a first camera, configured to obtain a first captured image;
a motion sensor, configured to obtain sensing parameters, wherein the sensing parameters are configured to characterize movement of an electronic device; and
one or more processors respectively connected to the first camera and the motion sensor, configured to: receive the first captured image and the sensing parameters; and, in response to the sensing parameters satisfying a switching condition, switch from the first camera to a second camera to obtain a second captured image, wherein the first camera is different from the second camera.

9. The electronic device according to claim 8, wherein:
the second camera is deployed in the electronic device; or, the second camera is deployed in a second electronic device that is communicatively connected to the electronic device.

10. The electronic device according to claim 8, wherein:
photographing ranges of the first camera and the second camera are different;
the switching condition is related to the photographing range; and
the switching condition indicates that the photographing range is larger when the movement amplitude of the electronic device is larger.

11. The electronic device according to claim 8, wherein the one or more processors are further configured to:
provide the sensing parameters to a processing engine, wherein:
the processing engine is configured to process a captured image obtained by a target camera device based on the sensing parameters;
when the sensing parameters satisfy the switching condition, switching from the first camera to the second camera to obtain the second captured image is performed before providing the sensing parameters to the processing engine.

12. The electronic device according to claim 11, wherein:
the processing engine is configured to: based on the captured image obtained by the target camera device and the sensing parameters obtained by the motion sensor, process the captured image to generate an output image,
wherein:
when the first camera serves as the target camera device and the sensing parameters satisfy the switching condition, the second camera is controlled to serve as the target camera device;
the first captured image corresponds to a first output image; and
the second captured image corresponds to a second output image.

13. The electronic device according to claim 12, wherein the one or more processors are further configured to display the output image, wherein:
a target object included in the first output image is located at a first position of the first output image;
the target object included in the second output image is located at a second position of the second output image; and
the first position of the target object when displaying the first output image is the same as the second position of the target object when displaying the second output image.

14. The electronic device according to claim 13, wherein:
the first captured image and the second captured image are captured images during a same recording process; and
the first output image and the second output image are storage images of a target file generated during the same recording process; or the first output image and the second output image are preview images provided to a display screen for display during the same recording process.

15. The electronic device according to claim 10, wherein:
when the photographing range of the first camera is smaller than the photographing range of the second camera, in response to the sensing parameters satisfying the switching condition, switching from the first camera to the second camera to obtain the second captured image includes:
determining the movement amplitude of the electronic device based on the sensing parameters;
when the average movement amplitude of the electronic device within a preset time period is larger than a first switching threshold, switching from the first camera to the second camera to obtain the second captured image;
when the average movement amplitude of the electronic device within the preset time period is less than a second switching threshold, switching from the second camera to the first camera to obtain the first captured image, wherein the second switching threshold is smaller than the first switching threshold.

16. A non-transitory computer readable storage medium containing computer instructions that, when being executed, cause at least one processor to perform:
obtaining a first captured image through a first camera;
obtaining sensing parameters through a motion sensor, wherein the sensing parameters are configured to characterize movement of an electronic device; and
in response to the sensing parameters satisfying a switching condition, switching from the first camera to a second camera to obtain a second captured image, wherein the first camera and the motion sensor belong to the same electronic device, and the first camera is different from the second camera.

17. The method according to claim 1, wherein:
photographing ranges of the first camera and the second camera are different;
the switching condition is related to the photographing range; and
the switching condition indicates that the photographing range is larger when the movement amplitude of the electronic device is larger.

18. The method according to claim 1, wherein the at least one processor is further configured to perform:
providing the sensing parameters to a processing engine, wherein:
the processing engine is configured to process a captured image obtained by a target camera device based on the sensing parameters;
when the sensing parameters satisfy the switching condition, switching from the first camera to the second camera to obtain the second captured image is performed before providing the sensing parameters to the processing engine.

19. The method according to claim 3, wherein:
the processing engine is configured to: based on the captured image obtained by the target camera device and the sensing parameters obtained by the motion sensor, process the captured image to generate an output image,
wherein:
when the first camera serves as the target camera device and the sensing parameters satisfy the switching condition, the second camera is controlled to serve as the target camera device;
the first captured image corresponds to a first output image; and
the second captured image corresponds to a second output image.

20. The method according to claim 4, wherein the at least one processor is further configured to perform:
displaying the output image, wherein:
a target object included in the first output image is located at a first position of the first output image;
the target object included in the second output image is located at a second position of the second output image; and
the first position of the target object when displaying the first output image is the same as the second position of the target object when displaying the second output image.
